(19) United States
(12) Patent Application Publication
(10) Pub. No.: US 2004/0056752 A1
(43) Pub. Date: Mar. 25, 2004

(54) Fuse belt and fuse assembling method

(75) Inventors: Hironori Kondo, Shizuoka (JP); Takayoshi Endo, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/618,653

(22) Filed: Jul. 15, 2003

(30) Foreign Application Priority Data
Jul. 15, 2002 (JP) P2002-205988

(51) Int. Cl. H01H 85/04

(52) U.S. Cl. 337/159; 29/623

(57) ABSTRACT

A plurality of fuse elements each having a pair of flat terminal pieces interconnected by a fusible part, and a coupling part for coupling the flat terminal pieces of each fuse element along the fuse belt are one-piece formed by pressing process. A fuse belt is formed by attaching an insulating housing covering the fusible part to each fuse element. The flat terminal pieces of each fuse element in the fuse belt are successively separated from the coupling part by cutting, and the fuses are mounted to fuse mounting parts of an electric junction box.

The present application is based on Japanese Patent Application No. 2002-205988, the entire contents of which are incorporated herein by reference.

### BACKGROUND OF THE INVENTION

1. Field of the Invention

The present invention relates to a fuse belt and a fuse assembling method. More particularly, the invention relates to a fuse belt and a fuse assembling method, which are well suitably used when blade type fuses are automatically assembled into fuse mounting parts of an electric junction box by using an automatic assembling machine.

2. Related Art

FIG. 9 is a perspective view showing an electric junction box 71 used for protecting various electric systems in a vehicle or the like.

This electric junction box 71 is called a fuse box or a fuse block. A number of fuse mounting parts 72, which insertionally receive blade type fuses 74, are arrayed in an upper part of a body case 71a made of insulating resin. Connection terminals of various electric systems which will connect to blade type fuses 74 that are inserted into the fuse mounting parts 72, are housed in the body case 71a.

The fuse 74 is a blade type fuse, in which a fusible part is provided between a pair of parallel metal flat terminal pieces (referred to as flat terminal pieces) 75a and 75b, to thereby form a fuse element 75. A base end (an end containing the fusible part) of the fuse element 75 is placed in an insulating housing 76.

The blade type fuse 74 is mounted to the fuse mounting part 72 of the electric junction box 71. The flat terminal pieces 75a and 75b are electrically connected to the mating terminals of the fuse mounting part 72.

The assembling of the fuses 74 into the electric junction box 71 is automatized for the purpose of labor saving.

Specifically, an automatic assembling process of the fuses 74 into the electric junction box 71 consists of a fuse supplying step of supplying the fuses 74 to a predetermined fuse supplying position, and an automatic assembling step of assembling the fuses 74, which have been supplied to the fuse supplying position, to the fuse mounting parts 72 of the electric junction box 71, which are positioned in a predetermined assembling position.

A part feeder in the conventional fuse supplying step includes a collector part (not shown) for collecting the fuses 74 from a storage part storing a number of the fuses 74, and a selective transportation part 77 for regulating attitudes of the collected fuses 74 and transporting those regulated fuses 74. The blade type fuses 74 are transported downstream by vibrating the selective transportation part 77 by a vibrating machine (not shown).

For example, as shown in FIG. 9, in the selective transportation part 77, the flat terminal pieces 75a and 75b are supported and guided by a groove 78, whereby only the fuses 74 having a regular attitude (in which the insulating housing 76 is directed upward) are selected and transported downstream to the fuse supplying position.

The blade type fuses 74 are supplied to the fuse supplying position, and are assembled into the fuse mounting parts 72 of the electric junction box 71 successively and continuously by an assembling robot or the like, in the automatic assembling step.

The blade type fuse 74 is standardized in outer dimensions. Therefore, even if the fuses are different in fuse capacity, the outer dimensions of those fuses are equal.

As described above, in the case that the fuses are fed by means of the part feeder, when a fuse which, for example, is dropped in the assembling place is returned to the storage part, if the fuse is put in another part feeder which handles fuses having fuse capacities being different from that of the dropped fuse, the dropped fuse is fed to another fuse supplying position. As a result, the fuse having the wrong capacity will mistakenly be assembled into the electric junction box 71.

The fuse 74 which is mistakenly assembled into the electric junction box 71 may be detected in, for example, an electrical conduction inspection carried out after the assembling. In this case, however, the inspection and part replacement work lowers the productivity.

The part feeder which regulates the attitudes of a number of blade type fuses 74 that are fed in different directions is very expensive. Therefore, use of the part feeder increases the cost to construct the equipment for automatizing the fuse assembling work is increased.

### SUMMARY OF THE INVENTION

An object of the present invention is directed to solve the above problems and to provide a fuse belt and a fuse assembling method which can surely prevent the fuse having the wrong capacity from being mistakenly assembled into the electric junction box, and can automatically assemble fuses without using the part feeder.

According to an aspect of the invention, there is provided a fuse belt comprising: a plurality of fuse elements each having a pair of flat terminal pieces interconnected by a fusible part; insulating housings for holding at least the fusible parts of the fuse elements; and a coupling part for coupling the flat terminal pieces of each fuse element so as to be aligned in a longitudinal direction of the belt.

According to another aspect of the invention, there is provided a fuse assembling method comprising the steps of: forming a plurality of fuse elements, each having a pair of flat terminal pieces and interconnected by a fusible part, and a coupling part for coupling the flat terminal pieces so as to be aligned into one-piece construction by pressing process; attaching each insulating housing covering the fusible part to each fuse element to thereby form a fuse belt; and mounting the fuses to fuse mounting parts of an electric junction box while successively separating the flat terminal pieces of each fuse element in the fuse belt from the coupling part by cutting.

According to a fuse belt and a fuse assembling method of the present invention, when fuses are automatically assembled into fuse mounting parts of an electric junction box by using an automatic assembling machine or the like, fuses are supplied to a predetermined fuse supplying position, in the form of a fuse belt formed with fuse elements having equal capacities being coupled so as to be aligned, and fuses are mounted to the fuse mounting parts of the electric junction box, while being successively separated from the fuse belt by cutting.

Therefore, there is no chance that the fuses having wrong capacities are supplied to the automatic assembling machine or the like. Accordingly, the fuse having the wrong capacity is surely prevented from being mistakenly assembled into the electric junction box.

Fuses are supplied, in the form of a fuse belt, to the automatic assembling machine or the like for assembling fuses into the fuse mounting part of the electric junction box. Since the fuses are uniformly oriented, there is no need of uniformly arranging fuses in their orientation by using an expensive part feeder.

In the fuse assembling method, after the flat terminal pieces of the fuse elements in the fuse belt are successively separated from the coupling part by cutting, the fuses are subjected to an inspection in conductivity, and qualified fuses are mounted to the fuse mounting parts of the electric junction box.

In this case, immediately before the fuses are mounted to the fuse mounting parts of the electric junction box, the fuses may be inspected in conductivity. Therefore, it is prevented that defective fuses are mounted to the fuse mounting parts. Manual work of removing a defect fuse from the fuse mounting part as in the case where fuses are inspected in conductivity in a post-process, is eliminated.

### BRIEF DESCRIPTION OF THE DRAWINGS

FIG. 1 is a partial cross sectional view showing a fuse belt which is an embodiment of the invention;

FIG. 2 is a partial cross sectional view for explaining a process of manufacturing the fuse belt shown in FIG. 1;

FIG. 3 is a partial cross sectional view for explaining a process of manufacturing the fuse belt shown in FIG. 1;

FIG. 4A is a perspective view of a whole fuse separated from the fuse belt shown in FIG. 1 and FIG. 4B is a partial cross sectional view showing the same;

FIG. 5 is a diagram for explaining a fuse assembling method for assembling fuses into fuse mounting parts of an electric junction box by using the fuse belt shown in FIG. 1;

FIG. 6 is a partial cross sectional view showing a fuse belt which is a second embodiment of the invention;

FIG. 7 is a partial cross sectional view for explaining a process of manufacturing the fuse belt shown in FIG. 6;

FIG. 8A is a perspective view of a whole fuse separated from the fuse belt shown in FIG. 6 and FIG. 8B is a partial cross sectional view showing the same; and

FIG. 9 is a perspective view showing for explaining a conventional fuse assembling method for a fuse into a fuse holder of an electric junction box.

### DETAILED DESCRIPTION OF THE PREFERRED EMBODIMENTS

A fuse belt and a fuse assembling method of preferred embodiments of the present invention will be described with reference to the accompanying drawings.

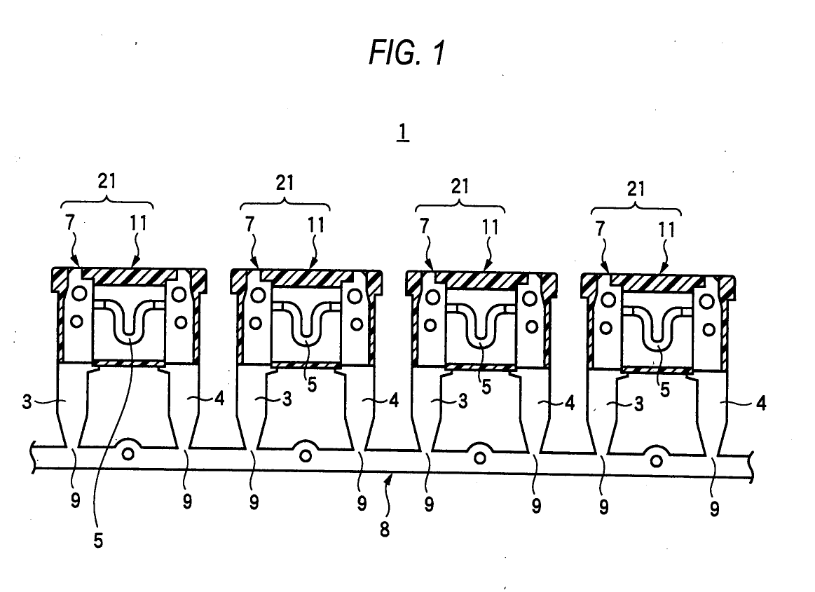

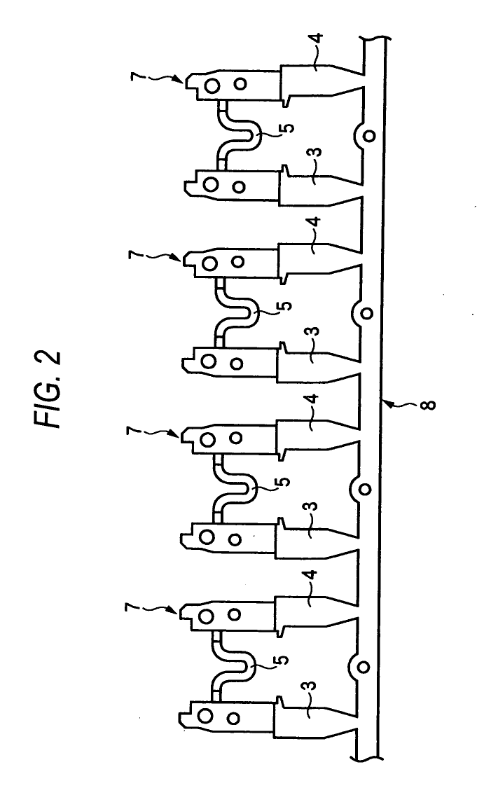

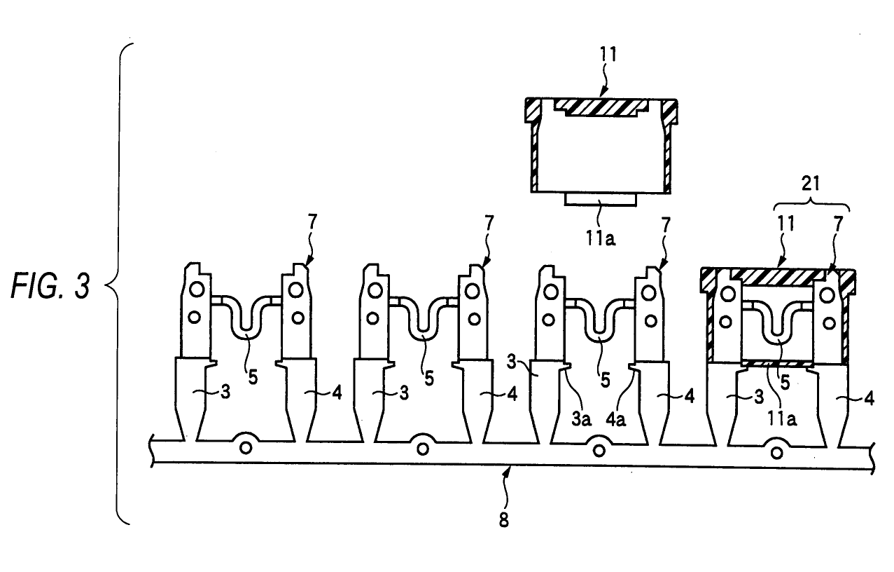

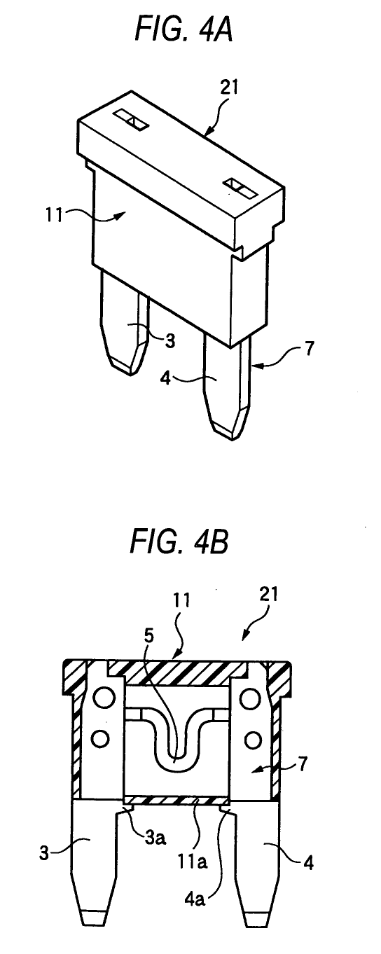

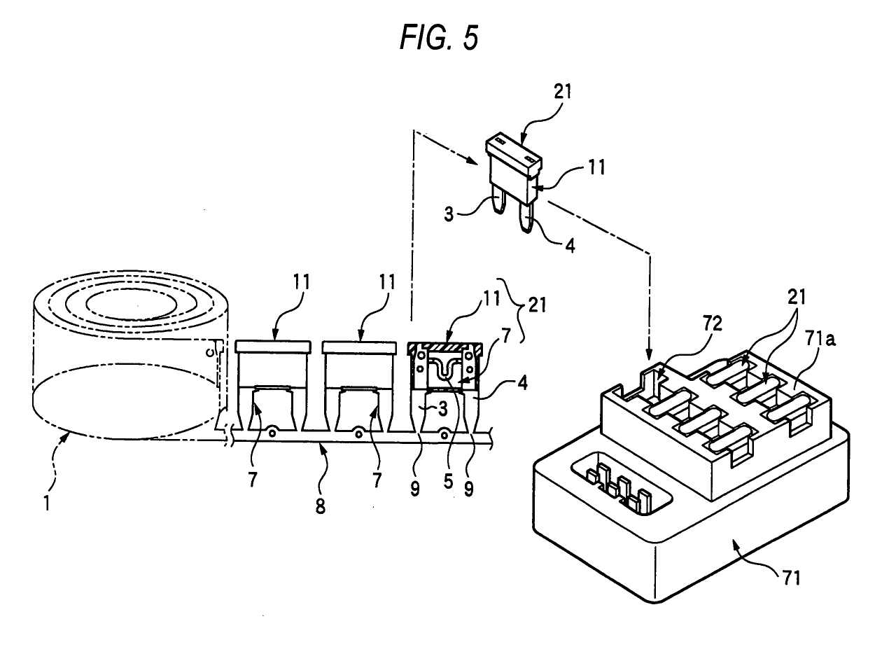

FIG. 1 is a partial cross sectional view showing a fuse belt which is an embodiment of the invention. FIGS. 2 and 3 are each a partial cross sectional view for explaining a process of manufacturing the fuse belt shown in FIG. 1. FIG. 4A is a perspective view of a whole fuse separated from the fuse belt shown in FIG. 1 and FIG. 4B is a partial cross sectional view showing the same. FIG. 5 is a diagram for explaining a fuse assembling method for assembling fuses into fuse mounting parts of an electric junction box by using the fuse belt shown in FIG. 1.

The fuse belt 1 according to the first embodiment, as shown in FIG. 1, is made up of a plurality of fuse elements 7 each having a pair of parallel flat terminal pieces 3 and 4 interconnected by a fusible part 5, insulating housings 11 for holding at least the fusible parts 5 of the fuse elements 7, and a coupling part 8 for coupling the flat terminal pieces 3 and 4 of each fuse element 7 so that the fuse elements 7 are aligned along the coupling part 8.

The flat terminal pieces 3 and 4, the fusible part 5, and the coupling part 8 are one-piece formed from a metal sheet by pressing process, as shown in FIG. 2.

The coupling part 8 takes the form of a strip extending in a direction in which the fuse elements 7 are arranged (horizontal direction in FIG. 1). The tips of the flat terminal pieces 3 and 4 of the fuse elements 7 are successively arrayed along one side line of the coupling part 8.

During the pressing process, the cross sectional area or the like of the fusible part 5 are adjusted in accordance with a required fuse capacity for fusing.

The insulating housing 11 is made of insulating synthetic resin, and holds the fuse elements 7 while covering the upper half of each fuse element. The insulating housing protects at least the fusible part 5 of each fuse. Further, the insulating housing maintains a predetermined positional relation between the flat terminal pieces 3 and 4, and prevents the fusible part 5 from being broken by external forces applied to the flat terminal pieces 3 and 4.

The fuse elements 7 installed with the insulating housings 11 in the fuse belt 1 become individual blade type fuses 21 as shown in FIGS. 4A and 4B when fuse belt is cut along the boundary parts 9 between the tips of the flat terminal pieces 3 and 4 and the coupling part 8.

In the fuse belt 1 of the first embodiment, the fuse elements 7 having the equal capacities are interconnected to one other so as to be aligned along the fuse belt 1, and those aligned fuse elements 7 are oriented in the same direction.

The insulating housings 11 are attached to the fuse elements 7 of the fuse belt 1, respectively, and individual blade type fuses 21 are obtained by merely cutting the boundary parts 9.

A method of assembling fuses 21 to the fuse mounting parts 72 of the electric junction box 71 by using the fuse belt 1 will be described.

Firstly, as shown in FIG. 2, a plurality of fuse elements 7 each having a pair of parallel flat terminal pieces 3 and 4 interconnected by a fusible part 5, and a coupling part 8 for coupling the flat terminal pieces 3 and 4 of the fuse elements 7 so as to be aligned along the fuse belt 1 are one-piece formed from a metal plate by pressing process.

Secondly, as shown in FIG. 3, the insulating housing 11 covering the fusible part 5 of the fuse element 7 is attached to the fuse element 7 from above, whereby a fuse belt 1 is formed as shown in FIG. 1. After the fuse elements 7 are mounted, terminal insertion holes of the insulating housing 11 are closed in a manner that a flap 11a integrally formed with the lower end of the insulating housing through a thin hinge is fastened to protrusions 3a and 4a of the flat terminal pieces 3 and 4.

As shown in FIG. 5, when fuses 21 are assembled into fuse mounting parts 72 of the electric junction box 71 by using an automatic assembling machine or the like, fuses are supplied to a predetermined fuse supplying position. In this case, the fuses take the form of a fuse belt 1 formed with fuse elements 7 having equal capacities being coupled along the fuse belt.

The fuse belt 1 supplied to the fuse supplying position is separate into fuses 21, while being cut at the boundary parts 9 each between the flat terminal pieces 3 and 4 of the fuse element 7 located at the tips of the fuse element 7 and the coupling part 8, and those separated fuses 21 are picked up by an assembling robot (not shown) or the like, and mounted to the fuse mounting parts 72 of the electric junction box 71.

The fuse belt 1 supplied to the fuse supplying position is such that the fuse elements 7 having the equal capacities are interconnected to one another so as to be aligned along the fuse belt 1. And, those fuses 21 are separated from the fuse belt 1 just before those fuses are mounted to the fuse mounting parts 72 of the electric junction box 71.

Therefore, it never happens that the fuses are supplied to the fuse supplying position in a state that those fuses include a fuse or fuses 21 being different in capacity from that of the former. Accordingly, it is surely prevented that the fuse 21 having the wrong capacity is mistakenly assembled into the electric junction box 71.

Accordingly, inspection and fuse replacement, which are performed after the fuse assembling work in order to cope with the mistaken assembling of the fuses 21 into the electric junction box 71, may be omitted. Accordingly, the automatic fuse assembling work to the electric junction box is more effectively performed.

The fuses 21 are supplied to the automatic assembling machine for assembling the fuses 21 to the fuse mounting parts 72 of the electric junction box 71 in a state that those fuses 21 take the form of a fuse belt 1 and are uniformly oriented.

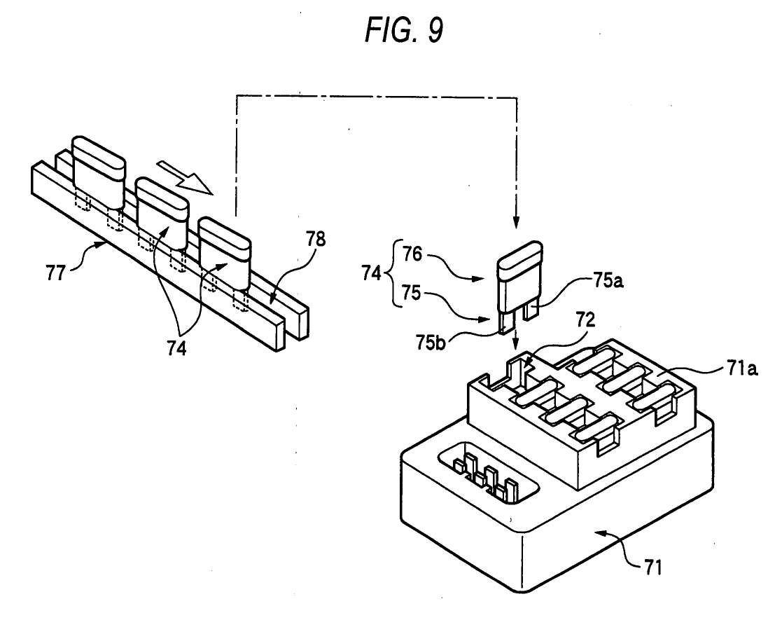

In the automatic assembling machine as described above, there is no need of using an expensive part feeder as shown in FIG. 9 to regulating the attitudes of a number of blade type fuses 74 that are fed in different directions. Accordingly, the cost to automatizing the fuse assembling work is reduced.

In the embodiment, the fuse belt 1 as formed in advance is rolled as shown in FIG. 5, and in this state, is supplied to a given fuse supplying position. The rolled fuse belt 1 is gradually pulled out with its leading end pulled out first. In this way, the automatic assembling line is arranged compact.

A process ranging from a step of pressing a plurality of fuse elements 7 from a metal plate to a step of assembling the fuses 21 into the electric junction box 71 may be carried out in an in-line manner.

The fuses may be assembled in the following manner. The flat terminal pieces 3 and 4 of the fuse elements 7 in the fuse belt 1 are successively separated from the coupling part 8 by cutting. Then, the fuses 21 are subjected to a conduction inspection, and only qualified fuses 21 are mounted to the fuse mounting parts 72 of the electric junction box 71.

In this case, immediately before the fuses 21 are mounted to the fuse mounting parts 72 of the electric junction box 71, the fuses 21 may be inspected in conductivity.

Therefore, it is prevented that defective fuses are mounted to the fuse mounting parts 72.

Manual work of removing a defect fuse from the fuse mounting part 72, and mounting another fuse thereto instead of the defective one as in the case where fuses are inspected in conductivity in a post-process, is eliminated and resultantly, the productivity is improved.

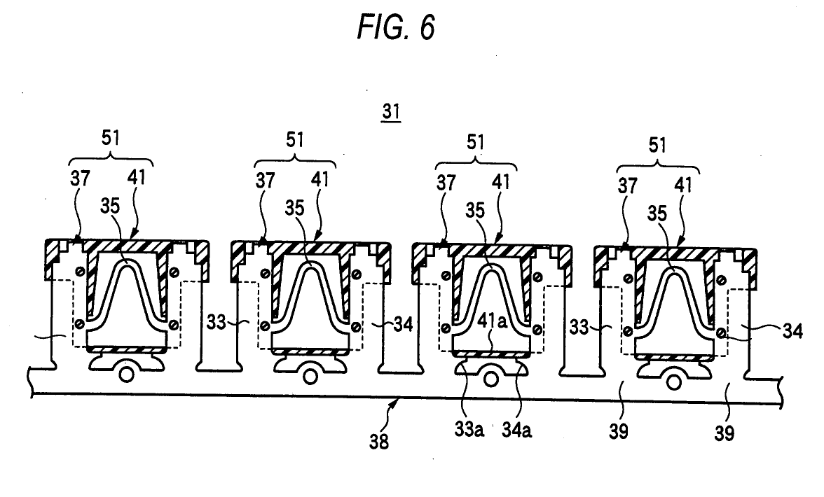

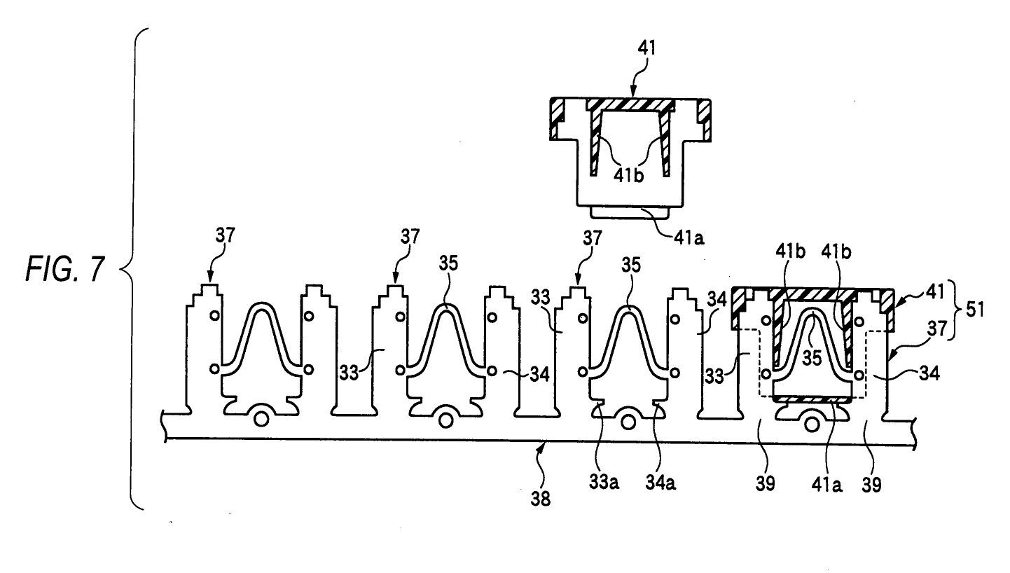

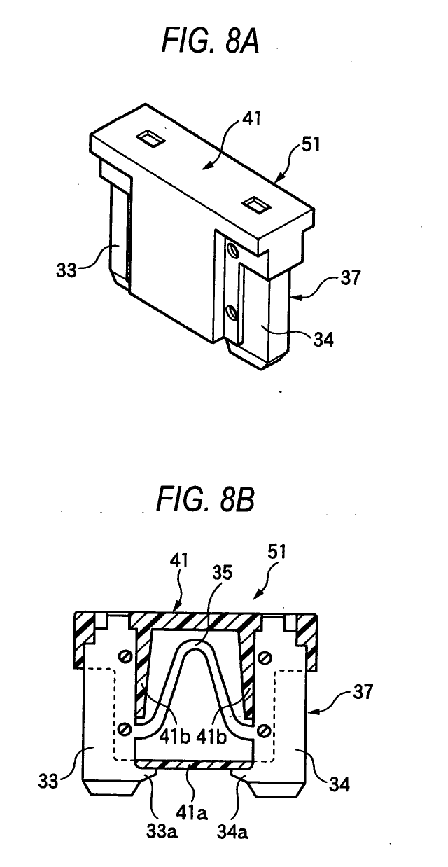

FIG. 6 is a partial cross sectional view showing a fuse belt which is a second embodiment of the invention. FIG. 7 is a partial cross sectional view for explaining a process of manufacturing the fuse belt shown in FIG. 6. FIG. 8A is a perspective view of a whole fuse separated from the fuse belt shown in FIG. 6 and FIG. 8B is a partial cross sectional view showing the same.

A fuse belt 31 according to the second embodiment, as shown in FIG. 6, is made up of a plurality of fuse elements 7 each having a pair of parallel flat terminal pieces 33 and 34 interconnected by a fusible part 35, an insulating housing 41, shaped like T, which covers the inner side edges and the upper edges of the flat terminal pieces 33 and 34 of each fuse element 37, and a coupling part 38 for coupling the flat terminal pieces 33 and 34 of each fuse element 37 so as to be aligned along the belt 31. Thus, the fuse belt 31 is of the called low-height type.

A basic construction of the fuse belt 31 of the second embodiment is substantially equal to that of the fuse belt 1 of the first embodiment already described. A plurality of fuse elements 37 each having a pair of flat terminal pieces 33 and 34 interconnected by a fusible part 35, and a coupling part 38 for interconnecting the fuse elements 37 so as to be aligned along the fuse belt 31 are one-piece formed from a metal plate by pressing process.

The coupling part 38 takes the form of a strip extending in a direction in which the fuse elements 37 are arranged (horizontal direction in FIG. 6). The tips of the flat terminal pieces 33 and 34 of the fuse elements 37 are successively arranged along one side line of the coupling part 38.

During the pressing process, the cross sectional area and the like of the fusible part 35 are adjusted in accordance with a fuse capacity of the fuse for its fusing.

The insulating housing 41 is made of insulating synthetic resin, and protects at least the fusible part fusible part 35 of each fuse elements 37. Further, the insulating housing maintains a predetermined positional relation between the flat terminal pieces 33 and 34, and prevents the fusible part 35 from being broken by external forces applied to the flat terminal pieces 33 and 34.

Insulation walls 41b provided in the insulating housing 41 function to increase a creepage distance for insulation between the parallel flat terminal pieces 33 and 34 to thereby increase the insulation performance, and further function to secure a holding strength of the fuse element 37. Further, the Insulation walls 41b function to prevent that the fusible part fusible part 35 fused by overcurrent scatters to within the insulating housing 41 to possibly cause secondary shortcircuiting.

The fuse elements 37 installed with the insulating housings 41 in the fuse belt 31 become individual blade type fuses 51 as shown in FIGS. 8A and 8B when fuse belt is cut along the boundary parts 39 between the tips of the flat terminal pieces 33 and 34 and the coupling part 38.

In the fuse belt 31 of the second embodiment, the fuse elements 37 having the equal capacities are interconnected to one other along the fuse belt 31, and those aligned fuse elements 37 are oriented in the same direction.

The insulating housings 41 are attached to the fuse elements 37 of the fuse belt 31, respectively, and individual blade type fuses 51 are obtained by merely cutting the boundary parts 39.

A method of mounting fuses 51 to the fuse mounting parts 72 of the electric junction box 71 by using the fuse belt 31 will be described.

Firstly, as shown in FIG. 7, a plurality of fuse elements 37 each having a pair of parallel flat terminal pieces 33 and 34 interconnected by a fusible part 35, and a coupling part 38 for coupling the flat terminal pieces 33 and 34 of the fuse elements 37 so as to be aligned along the fuse belt 31 are one-piece formed from a metal plate by pressing process.

Secondly, the insulating housing 41 covering the fusible part 35 of the fuse element 37 is attached to the fuse element 37 from above, whereby a fuse belt 31 is formed as shown in FIG. 6. After the fuse elements 37 are mounted, terminal insertion holes of the insulating housing 41 are closed in a manner that a flap 41a integrally formed with the lower end of the insulating housing through a thin hinge is fastened to protrusions 34a and 44a of the flat terminal pieces 43 and 44.

When the fuses 51 are assembled into fuse mounting parts 72 of the electric junction box 71 by using an automatic assembling machine or the like, fuses are supplied to a predetermined fuse supplying position. In this case, the fuses take the form of a fuse belt 31 formed with fuse elements 37 having equal capacities being coupled along the fuse belt 31.

The fuse belt 31 supplied to the fuse supplying position is separate into fuses 51, while being cut at the boundary parts 39 each between the flat terminal pieces 33 and 34 of the fuse element 37 located at the tips of the fuse element and the coupling part 38, and those separated fuses 51 are picked up by an assembling robot (not shown) or the like, and mounted to the fuse mounting parts 72 of the electric junction box 71.

The fuse belt 31 supplied to the fuse supplying position is such that the fuse elements 37 having the equal capacities are interconnected to one another so as to be aligned along the fuse belt 31. And, those fuses 51 are separated from the fuse belt 31 just before those fuses are mounted to the fuse mounting parts 72 of the electric junction box 71.

Therefore, it never happens that the fuses are supplied to the fuse supplying position in a state that those fuses include a fuse or fuses 51 being different in capacity from that of the former. Accordingly, it is surely prevented that the fuse 51 having the wrong capacity is mistakenly assembled into the electric junction box 71.

Accordingly, inspection and fuse replacement, which are performed after the fuse assembling work in order to cope with the mistaken assembling of the fuses 51 into the electric junction box 71, may be omitted. Accordingly, the automatic fuse assembling work into the electric junction box is more effectively performed.

The fuses 21 are supplied to the automatic assembling machine for assembling the fuses 51 to the fuse mounting parts 72 of the electric junction box 71 in a state that those fuses 51 take the form of a fuse belt 31 and are uniformly oriented.

In the automatic assembling machine as described above, there is no need of using an expensive part feeder to regulating the attitudes of a number of blade type fuses 74 that are fed in different directions. Accordingly, the cost to automatizing the fuse assembling work is reduced.

In the fuse belt of the low height type, such as the fuses 51, the inner edges and the upper edge of the flat terminal pieces 33 and 34, together with the fusible part fusible part 35, are covered with the insulating housing 41, as shown in FIGS. 8A and 8B. Therefore, tab terminal parts greatly protruded outward from the insulating housing 41, such as both the flat terminal pieces 75a and 75b in the conventional fuse 74 shown in FIG. 9, are not present. Accordingly, the fuse belt is rectangular in shape when viewed from front.

In the case of a part feeder in which the tab terminals of the fuse are supported and guided by the groove 78 and only the fuses having a regular attitude are selected and transported downstream, as in the selective transportation part 77 shown in FIG. 9, it is very difficult to select and transport the fuse belt of the low height type. For this reason, an efficiency of feeding fuses to the fuse supplying position is not good.

The fuse belt 31 of the instant embodiment completely solves such a problem.

In a fuse belt and a fuse assembling method of the invention, the fuse element, the insulating housing, the boundary part and the like are not limited to those discussed in the embodiments mentioned above, but those may variously be changed, modified and altered, and changed within the scope of the invention.

While in the fuse belt 1 (31) of each embodiment mentioned above, the fuse elements 7 (37) are formed on and along one side edge of the coupling part 8 (38), those fuse elements may be formed on and along both side edges of the coupling part.

As seen from the foregoing description, according to a fuse belt and a fuse assembling method of the present invention, when fuses are automatically assembled into fuse mounting parts of an electric junction box by using an automatic assembling machine or the like, fuses are supplied to a predetermined fuse supplying position, in the form of a fuse belt formed with fuse elements having equal capacities being coupled so as to be aligned along the fuse belt, and fuses are mounted to the fuse mounting parts of the electric junction box, while being successively separated from the fuse belt by cutting.

Therefore, there is no chance that the fuses are supplied to the automatic assembling machine or the like, while containing a fuse having a capacity which is different from that of the former. Accordingly, the fuse having the wrong capacity is surely prevented from being mistakenly assembled into the electric junction box.

Fuses are supplied, in the form of a fuse belt, to the automatic assembling machine or the like for assembling fuses into the fuse mounting part of the electric junction box. Since the fuses are uniformly oriented, there is no need of uniformly arranging fuses in their orientation by using an expensive part feeder.

Accordingly, the present invention succeeds in providing a fuse belt and a fuse assembling method which can surely prevent the fuse having the wrong capacity from being mistakenly assembled into the electric junction box, and can automatically assemble fuses without using the part feeder.

What is claimed is:

1. A fuse belt comprising:
a plurality of fuse elements, each of which includes
a pair of flat terminal pieces interconnected by a fusible part, and
an insulating housing in which at least said fusible part is accommodated; and
a coupling part to which said flat terminal pieces of said fuse elements are coupled so as to be aligned along said coupling part.

2. A fuse assembling method comprising the steps of:
integrally forming by pressing a plurality of fuse elements, each of which includes a pair of flat terminal pieces interconnected by a fusible part, and a coupling part to which said flat terminal pieces of said fuse elements are coupled, so that said fuse elements are aligned along said coupling part;
attaching an insulating housing so as to cover said fusible part to each of said fuse elements; and
separating the flat terminal pieces of one of said fuse elements from said coupling part by cutting so as to provide a fuse constituted by one of said fuse element covered with said insulating housing; and
mounting said fuse to a fuse mounting part in an electric junction box.

3. A fuse assembling method according to claim 2, wherein after said flat terminal pieces of said fuse element are separated from said coupling part, said fuses are subjected to a conduction inspection, and only qualified fuses are mounted to said fuse mounting parts of said electric junction box.

4. A fuse assembling method according to claim 2, wherein a plurality of said fuse elements are separated from said coupling part successively, whereby fuses are mounted to fuse mounting parts in the electric junction boxes, continuously.

5. A fuse assembling method according to claim 1, wherein inner edges and upper edges of said pair of flat terminal pieces of each fuse element are covered with said insulating housing.

6. A fuse belt comprising a plurality of fuses and a coupling part, wherein each of said fuses includes a pair of terminal pieces and a fusible part connecting said pair of terminal pieces, and said fuses are coupled to said coupling part so as to be aligned along said coupling part.

7. A fuse belt according to claim 6, wherein said terminal pieces, fusible part and said coupling part are integrally formed from a singe plate material in a pressing process.

8. A fuse belt according to claim 7, wherein a fuse capacity of said fuse is set by changing a sectional area of said fusible part formed in the pressing process.

9. A fuse belt according to claim 6, wherein inner edges and upper edges of said pair of flat terminal pieces of each fuse are covered with an insulating housing.

10. A continuous fuse assembling method using a fuse belt according to claim 6, wherein said fuses are separated from said coupling part of said fuse belt successively, and mounted to fuse mounting parts in electric junction boxes, continuously.
